(19) United States
(12) Patent Application Publication
(10) Pub. No.: US 2003/0174239 A1
(43) Pub. Date: Sep. 18, 2003

(54) Actuator and optical apparatus using the same

(75) Inventor: Toru Sawada, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/385,051

(22) Filed: Mar. 10, 2003

(30) Foreign Application Priority Data
Mar. 12, 2002 (JP) 2002-067399

(51) Int. Cl. H04N 5/225

(52) U.S. Cl. 348/373; 348/211.4

(57) ABSTRACT

An actuator includes a first rotating member rotatable on a first rotating axis, a second rotating member rotatable on a second rotating axis separately crossing the first rotating axis, and a lever having connecting holes for mounting a device. The lever converts the rotation of each of the rotating members into a motion that changes the position thereof. Each of the first and second rotating members is driven by a VCM composed of a coil member and a magnet.

### BACKGROUND OF THE INVENTION

1. Field of the Invention

The present invention relates to an actuator having a compact panning and tilting mechanism, and to an optical apparatus in which an optical device is attached to the actuator.

2. Description of the Related Art

Surveillance cameras, floodlights, and the like having a panning and tilting mechanism that can rotate on the horizontal axis and the vertical axis have been used in various fields. In general, the panning and tilting mechanism combines horizontal rotation on the vertical axis, and vertical rotation on the horizontal axis.

For example, as shown in FIG. 10, a known type of camera swivel device includes two DC motors 201 and 208. The DC motor 208 causes a horizontal rotation mount 207 to horizontally rotate on a vertical shaft 206 by a combination of horizontal rotation gears (not shown). The DC motor 201 causes a horizontal shaft 202 placed on the horizontal rotation mount 207 to vertically rotate, by a combination of a worm gear 204 and a vertically rotating gear 205. The horizontal shaft 202 is connected to a camera fixing mount 203, and a surveillance camera (not shown) is mounted on the camera fixing mount 203.

In the camera swivel device, when the DC motor 208 is driven, the camera is panned in the horizontal direction in accordance with the direction and amount of rotation of the motor shaft. When the DC motor 201 is driven, the camera is tilted in the elevating and declining directions, that is, in the vertical direction, in accordance with the direction and amount of rotation of the motor shaft. Therefore, the camera can be panned and tilted in an arbitrary direction by appropriately controlling the driving of the DC motors 201 and 208. Moreover, scanning can be performed by continuously driving the DC motors 201 and 208 according to a predetermined program.

In recent years, small information devices, such as mobile computers and portable telephones, having a CCD camera or the like mounted therein have been developed and become widespread. It is inconvenient that the camera is fixed to the main body of the information device, because the viewing angle is limited. Accordingly, there has been a demand to add a panning and tilting function to the camera while satisfying the essential requirement for the small information device, that is, size reduction. In this case, while it is only necessary to simply attach the camera to rotation shafts when the panning and tilting operation is performed manually, a high-responsivity compact panning and tilting mechanism that can be electronically controlled by the main unit of the information device is necessary in order to electrically control the panning and tilting angle with high precision, to perform automatic scanning, or to change the panning and tilting angle according to a given program.

However, the above known panning and tilting mechanism, in which the horizontal rotation and the vertical rotation are combined using two DC motors and the gears, cannot satisfy the request for size reduction, and cannot be easily applied to small information devices.

In the field of floodlights, for example, in order to pan and tilt an illuminating lamp at the leading end of a fiberscope, since the large panning and tilting mechanism described above cannot be mounted at the leading end of the fiberscope, the panning and tilting angle of the illuminating lamp is conventionally adjusted by towing, at hand, a plurality of wires extending between both ends of the fiberscope along the peripheral wall thereof. In this method, however, it is impossible to precisely control the panning and tilting angle and to continuously perform scanning according to a program.

Furthermore, in the fields of various machines and toys other than the optical apparatuses, there has been a strong demand for an actuator having an electronically-controlled compact panning and tilting mechanism.

### SUMMARY OF THE INVENTION

The present invention has been made in order to overcome the above problems, and an object of the present invention is to provide an actuator having an electronically-controlled compact panning and tilting mechanism, and an optical apparatus using the actuator.

In order to achieve the above object, according to an aspect, the present invention provides an actuator including a first rotating member rotatable on a first rotating axis, a second rotating member rotatable on a second rotating axis separately crossing the first rotating axis, and a lever, having a portion for mounting an object, that converts the rotational motion of each of the first and second rotating members into a motion that changes the position thereof, for example, panning or tilting, wherein at least one of the first and second rotating members is rotationally driven by a voice coil motor (VCM) composed of a coil and a magnet.

Preferably, the second rotating member has a slit extending along the second rotating axis, and the position of the lever is changed while the lever is born by the first rotating member to pivot along the first rotating axis and to move in conjunction with the rotation of the first rotating member on the first rotating axis, and while the lever extends through the slit to pivot along the second rotating axis and to move in conjunction with the rotation of the second rotating member on the second rotating axis.

In this case, the lever can be electrically panned and tilted, and the device attached to the lever can be precisely, quickly, and efficiently subjected to the position-changing motion.

In a general type of VCM, a magnet and a coil are arranged so as to move in parallel without contact with each other, and the direction and amount of relative movement of the magnet and the coil can be arbitrarily determined in accordance with the direction and amount of a current to be passed through the coil.

Therefore, by fixing one of the coil and the magnet in the voice coil motor to the rotating member in a plane perpendicular to the rotating axis of the rotating member and attaching the other to a fixed mount in parallel, the rotating member is rotated in a predetermined direction and by a predetermined rotation angle by the application of a current to the voice coil motor. Since the lever pivots in accordance with the direction and amount of rotation of the rotating member, the pivoting position of the lever can be precisely determined by controlling the direction and amount of a current to be passed through the voice coil motor.

When the first and second rotating members are driven by the voice coil motor, quiet driving is possible because gears and the like are not used to transmit the power, unlike the conventional panning and tilting mechanism. Moreover, since the driving force is immediately converted into the position-changing motion of the lever, the energy efficiency and responsivity are increased. While the combination of the DC motors and the gears, as in the conventional art, is incapable of precisely controlling the panning and tilting angle and of performing braking, since the amount of a current to be passed through the coil precisely corresponds to the amount of movement in the voice coil motor, the accuracy in controlling the panning and tilting angle is increased. In addition, since the transmission member used in the actuator is not an irreversible transmission member, such as a worm gear, that is used in the known panning and tilting mechanism, it will not be fractured even when the pivoting position of the lever is forcibly changed by external force.

Preferably, the lever is born by the first rotating member to pivot along the first rotating axis, the second rotating member has a slit extending along the second rotating axis, and the lever can pivot in engagement with the slit.

In this mechanism, since the lever is born by the first rotating member, when the first rotating member rotates, the lever also pivots on the first rotating axis. On the other hand, the second rotating member has a slit extending along the second rotating axis, and the lever is pivotally engaged with the slit. Therefore, when the second rotating member rotates, the lever is pivoted along the first rotating axis without obstructing the rotation of the first rotating member. Consequently, the lever can pivot along both the first rotating axis and the second rotating axis, and a position-changing motion, such as panning or tilting, in all directions is possible.

Preferably, the actuator further includes a driving circuit for driving the voice coil motor.

In this case, the lever can be automatically caused to make a position-changing motion, such as a panning and tilting motion, to change the direction to a predetermined direction in response to an electric command from the outside, and scanning can also be performed.

Preferably, the actuator further includes a measurement section for measuring the rotating position of each of the rotating members.

The panning or tilting position of the actuator can more precisely correspond to an electric signal from the outside by measuring an actual panning or tilting position corresponding to the command and by feeding information about the measured position back to an external control circuit when the actuator is automatically panned or tilted according to the electric command.

As the measurement section for measuring the rotating position of the rotating member, for example, a potentiometer, an encoder, or a capacitive position sensor may be used.

According to another aspect, the present invention provides an optical apparatus including any of the above actuators, and an optical device, wherein the optical device attached to the lever. Preferably, the optical device is attached to the lever so that an optical axis or an extension line thereof to be subjected to a position-changing motion is aligned with or is in parallel with the axis of the lever.

The optical device may include a light projecting device, such as a floodlight, a light emitting diode, or a laser, a light guide device, such as a lens, an optical fiber, a mirror, or a half mirror, and a light receiving device such as a camera or a photoreceptor. In any case, it is possible to achieve a tiltable optical apparatus that has a substantially reduced size and a higher responsivity.

In particular, the optical axis of the optical device can be tiltable in all directions by attaching the optical device so that the optical axis or an extension line thereof is aligned with or is in parallel with the axis of the lever.

Further objects, features, and advantages of the present invention will become apparent from the following description of the preferred embodiments with reference to the attached drawings.

### BRIEF DESCRIPTION OF THE DRAWINGS

FIG. 1 is a transparent perspective view showing principal components of an actuator according to an embodiment of the present invention;

FIG. 2 is a perspective view of the principal parts of the actuator, separated along the X-, Y-, and S-axes;

FIG. 3 is a side view of a part of the actuator, as viewed from the X-axis side;

FIG. 4 is a block diagram showing a circuit configuration of a circuit board in the actuator;

FIGS. 5A and 5B are transparent side views showing an operating manner of the actuator, respectively, as viewed from the Y-axis side and the X-axis side;

FIGS. 6A and 6B are transparent side views showing another operating manner of the actuator, respectively, as viewed from the Y-axis side and the X-axis side;

FIGS. 7A and 7B are transparent side views showing a further operating manner of the actuator, respectively, as viewed from the Y-axis side and the X-axis side;

FIG. 8 is a perspective view of an optical apparatus according to another embodiment of the present invention;

FIG. 9 is a perspective view of a notebook personal computer having the optical apparatus of the embodiment; and

FIG. 10 is a perspective view of a known tilting mechanism.

### DESCRIPTION OF THE PREFERRED EMBODIMENTS

While preferred embodiments of the present invention will now be described, it is to be understood that the invention is not limited to the embodiments. The attached drawings are used to explain the concepts of the present invention. In the drawings, components unnecessary for explanation are omitted, and the shapes and scales of the components do not necessarily reflect actual shapes and scales.

[First Embodiment]

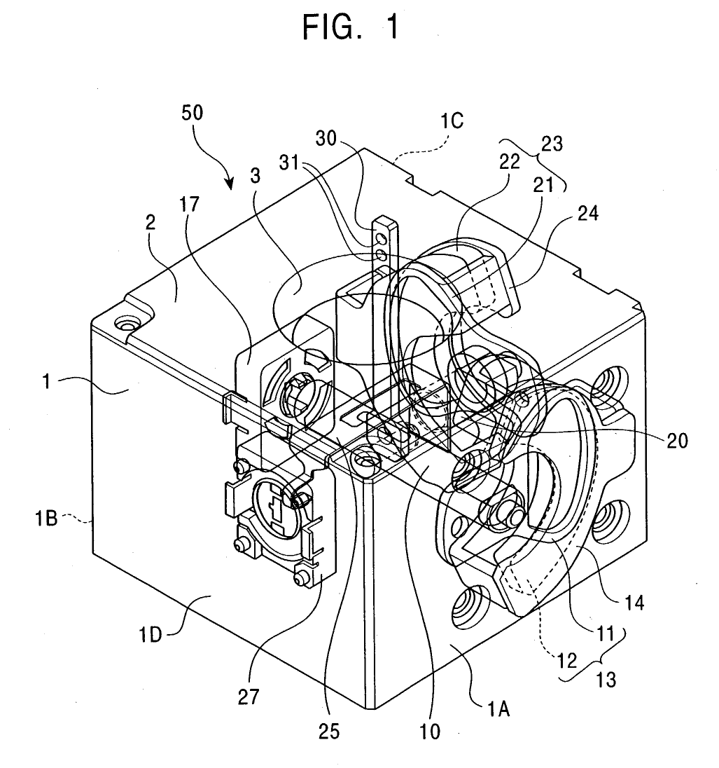

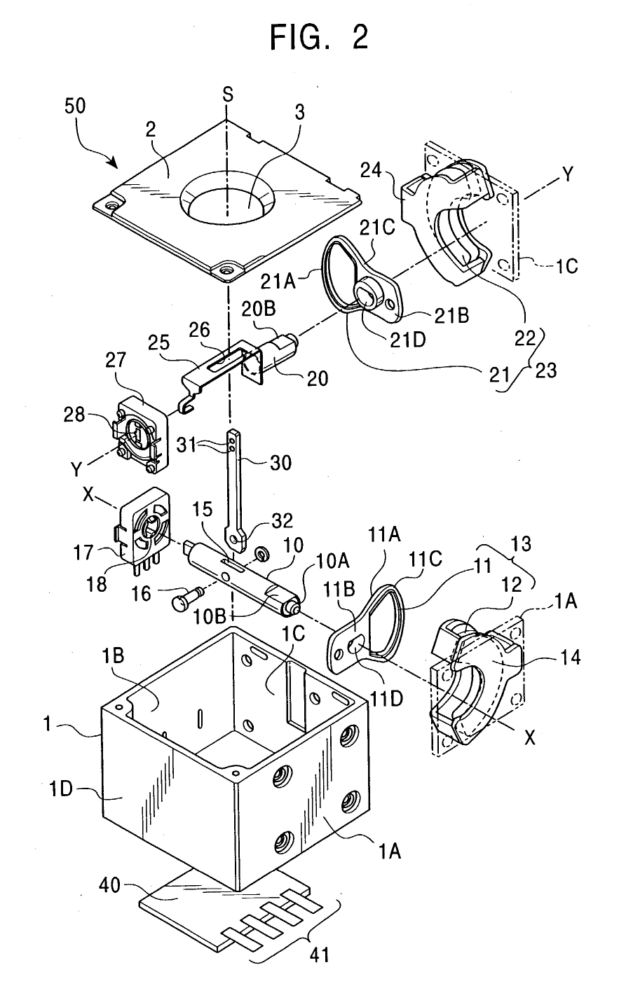

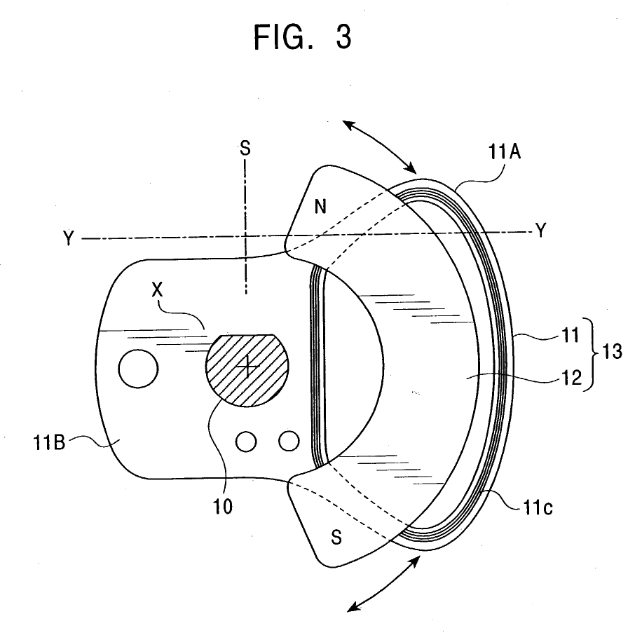

FIG. 1 is a transparent perspective view of principal components of an actuator (pan head) according to a first embodiment of the present invention, FIG. 2 is an exploded perspective view of the actuator in which the principal components are separated along the X-, Y-, and S-axes, and FIG. 3 is a side view of a part of the actuator, as viewed from the X-axis side.

Referring to FIGS. 1 and 2, an actuator (pan head) 50 of the first embodiment includes a first rotating member 10 that rotates on a first rotating axis X, a second rotating member 20 that rotates on a second rotating axis Y extending separate from and perpendicular to the first rotating axis X, and a lever 30 having connecting holes (screw holes, mounting means) 31 used to mount an object (device) to be subjected to a position-changing motion such as panning or tilting.

The first rotating member 10 is shaped like a cylinder extending along the first rotating axis X, and a coil member 11 is fitted on one end thereof. A cylindrical projection 10A is formed at the end of the first rotating member 10 on which the coil member 11 is fitted, and is born by a receiver (not shown) on the inner side of a side face 1A of a chassis 1.

The coil member 11 includes a fan-shaped annular frame portion 11A, a flat receiving portion 11B extending from the frame portion 11A, and a coil portion 11C, such as a printed coil, formed of a looped conducting wire. The coil member 11 is connected to the first rotating member 10 so that it can swing in a plane perpendicular to the first rotating axis X while the loop of the conducting wire is placed in the plane perpendicular to the first rotating axis X, and a cutout shaft portion 10B at the end of the first rotating member 10 extends through a support hole 11D formed in the receiving portion 11B.

Therefore, the first rotating member 10 is connected to the coil member 11 so that it rotates on its axis in conjunction with the swing motion of the coil member 11.

A yoke 14 formed of a combination of a pair of horseshoe-shaped yoke members is fixed onto the inner wall of the side face 1A of the chassis 1, and a magnet 12 curved like a horseshoe is mounted inside the yoke 14. As shown in FIG. 3, the magnet 12 is placed so that the coil member 11 that swings on the first rotating axis X moves in parallel without contact with the magnet 12. The coil member 11 and the magnet 12 constitute a first VCM (voice coil motor) 13.

A slit 15 extends at the center of the first rotating member 10 along the first rotating axis X. A pin 16 extending in a direction perpendicular to the first rotating axis X is passed through the slit 15. A bore 32 is formed at an end of the lever 30 remote from the connecting holes 31. The pin 16 is passed through the bore 32 so that the lever 30 can pivot sideward along the first rotating axis X in a plane including the first rotating axis X.

An end of the first rotating member 10 remote from the end with the coil member 11 is born by a rotation sensor 17 that also functions as a receiver. The rotation sensor 17 is a rotary potentiometer that can detect and output the rotating position of a rotor 18 connected to the end of the first rotating member 10 as a potential difference. The rotation sensor 17 is fixed on the inner wall of a side face 1B of the chassis 1A opposing the side face 1A.

The second rotating member 20 is shaped like a cylinder extending along the second rotating axis Y, and a coil member 21 is fitted on one end thereof. The end of the second rotating member 20 on which the coil member 21 is fitted is born by a receiver (not shown) on a side face 1C of the chassis 1. The coil member 21 includes a fan-shaped annular frame portion 21A, a flat receiving portion 21B extending from the frame portion 21A, and a coil portion 21C formed of a conducting wire looped in the circumferential direction of the frame portion 21A. The coil member 21 is connected to the second rotating member 20 so that it can swing in a plane perpendicular to the second rotating axis Y while the loop of the conducting wire is placed in the plane perpendicular to the second rotating axis Y, and a cutout shaft portion 20B at the end of the second rotating member 20 extends through a support hole 21D formed in the receiving portion 21B.

A yoke 24 formed of a combination of a pair of horseshoe-shaped yoke members is fixed onto the inner wall of the side face 1C of the chassis 1, and a magnet 22 curved like a horseshoe is mounted inside the yoke 24. The magnet 22 is placed so that the swinging coil member 21 moves in parallel without contact with the magnet 22. The coil member 21 and the magnet 22 constitute a second VCM 23.

A support plate 25 having a slit 26 extending along the second rotating axis Y is formed at the center of the second rotating member 20. The lever 30 is passed through the slit 26, and the slit 26 has a width and length such that the lever 30 can freely pivot along the second rotating axis Y.

An end of the second rotating member 20 remote from the end with the coil member 21 is born by a rotation sensor 27 that also functions as a receiver. The rotation sensor 27 is a rotary potentiometer that can detect and output the rotating position of a rotor 28 connected to the end of the second rotating member 20 as a potential difference. The rotation sensor 27 is fixed on the inner wall of a side face 1D of the chassis 1A opposing the side face 1C.

A cover 2 is mounted at an upper opening of the chassis 1. An aperture 3 is formed at the center of the cover 2. One end of the lever 30, that is, the end having the connecting holes 31 protrudes from the aperture 3. The aperture 3 has a bore enough to allow the lever 30 to pivot for panning or tilting. A circuit board 40 is provided at the bottom of the chassis 1.

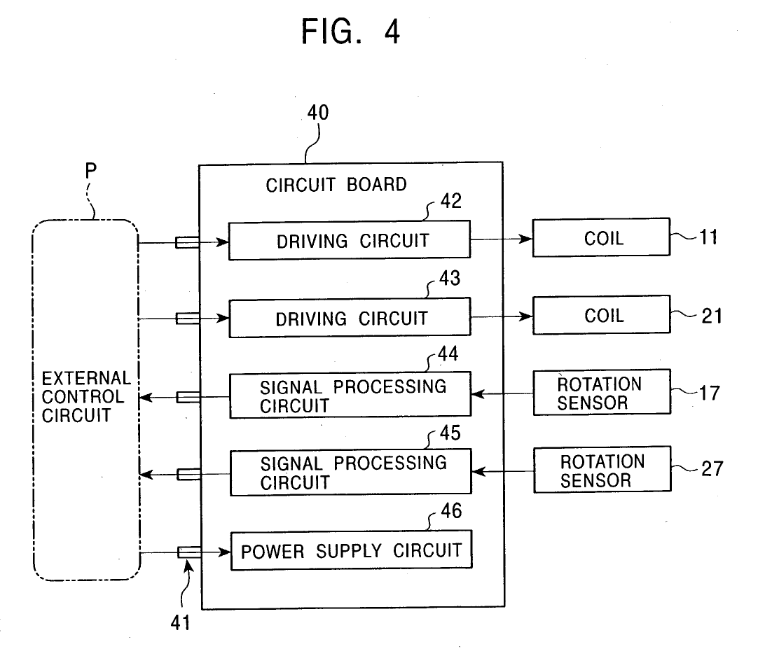

FIG. 4 shows an example of a circuit configuration of the circuit board 40. As shown in FIG. 4, the circuit board 40 includes a driving circuit 42 for the first VCM 13, a driving circuit 43 for the second VCM 23, a signal processing circuit 44 for the rotation sensor 17, a signal processing circuit 45 for the rotation sensor 27, and a power supply circuit 46.

The driving circuit 42, the driving circuit 43, the signal processing circuit 44, and the signal processing circuit 45 are electrically connected to the coil portion 11C of the coil member 11 attached to the first rotating member 10, the coil portion 21C of the coil member 21 attached to the second rotating member 20, the rotation sensor 17 attached to the first rotating member 10, and the rotation sensor 27 attached to the second rotating member 20, respectively. The power supply circuit 46 supplies a required power to the above circuits. The above circuits are also connected to an external control circuit P through terminals 41 provided in the circuit board 40.

The operating manner of the actuator 50 will now be described.

When it is assumed that a command to rotate the first rotating member 10 is given from the external control circuit P shown in FIG. 4 to the driving circuit 42 for the first VCM 13, the driving circuit 42 receives power from the power supply circuit 46, determines the direction and amount of current to be passed through the coil portion 11C of the first VCM 13 for driving the first rotating member 10, and feeds the current. The coil portion 11C thereby generates a magnetic field, and the coil member 11 turns on the first rotating axis X along the magnet 12 in the determined direction and the determined angle. In response to the turning of the coil member 11, the first rotating member 10 rotates, and therefore, the lever 30 connected to the first rotating member 10 pivots on the first rotating axis X in a determined direction and by a determined angle. In this case, since the slit 26 of the second rotating member 20 has a width and length such that the lever 30 can freely pivot along the second rotating axis Y, the pivotal motion on the first rotating axis X of the lever 30 will not be obstructed by the engagement with the slit 26.

When the first rotating member 10 rotates, the rotation sensor 17 detects the rotating position of the first rotating member 10, and sends information about the detected position to the external control circuit P through the signal processing circuit 44 for the rotation sensor 17. The external control circuit P feeds the information back to the driving circuit 42 for the first VCM 13, and precisely controls the amount of current to be passed through the coil portion 11C. Consequently, the rotation angle of the first rotating member 10 is determined precisely.

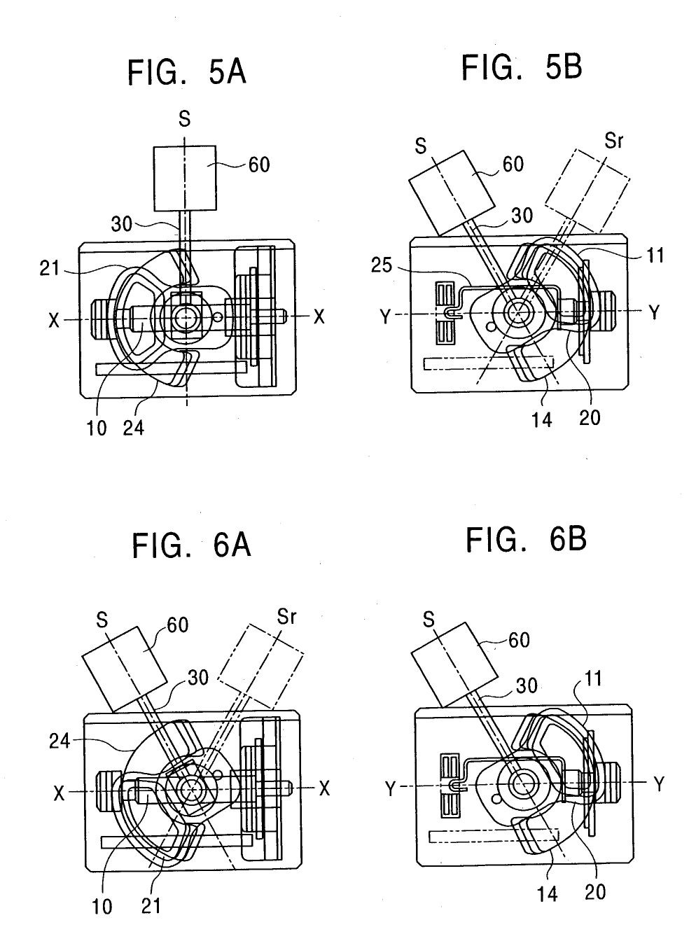

FIGS. 5A and 5B are transparent side views showing a state in which the lever 30 is pivoted on the first rotating axis X in one direction (leftward in the figure). FIG. 5A is a side view, as viewed from the Y-axis direction, and FIG. 5B is a side view, as viewed from the X-axis direction. In these figures, a device to be subjected to a position-changing motion, more specifically, an optical device, such as a CCD camera, 60 is mounted at the leading end of the lever 30. An axis S of the lever 30 is placed in a neutral position in the Y-axis direction, and is pivoted on the first rotating axis X in the leftward direction in the figures. By reversing the direction of the current that is passed through the coil portion 11C, the axis S of the lever 30 remains in a neutral position in the Y-axis direction, but is pivoted on the first rotating axis X in the rightward direction, as shown by “Sr” in FIG. 5B.

Next, it is assumed that a command to rotate the second rotating member 20 is given from the external control circuit P to the driving circuit 43 for the second VCM 23. In this case, the above-described command given to the driving circuit 42 for the first VCM 13 is held. The driving circuit 43 for the second VCM 23 receives power supplied from the power supply circuit 46, determines the direction and amount of current to be passed through the coil portion 21C of the second VCM 23, and feeds the current. The coil portion 21 thereby generates a magnetic field, and the coil member 21 turns on the second rotating axis Y along the magnet 22 in the determined direction and by the determined angle. When the coil member 21 turns, the slit 26 of the second rotating member 20 also turns. Consequently, the lever 30 engaged with the slit 26 pivots on the second rotating axis Y in a determined direction and by a determined angle. In this case, since the slit 26 has a width and length such that the lever 30 can freely pivot along the second rotating axis Y, the pivotal movement on the first rotating axis X of the lever 30 will not be obstructed by the engagement with the slit 26.

When the second rotating member 20 rotates, the rotation sensor 27 detects the rotating position of the second rotating member 20, and sends information about the detected position to the external control circuit P through the signal processing circuit 45 for the rotation sensor 27. The external control circuit P feeds the information back to the driving circuit 43 for the second VCM 23, and precisely controls the amount of current to be passed through the coil portion 21C. Consequently, the rotation angle of the second rotating member 20 is determined precisely.

FIGS. 6A and 6B are transparent side views showing a state in which the lever 30 is pivoted on the second rotating axis Y in one direction (leftward in the figure) from the position shown in FIGS. 5A and 5B. FIG. 6A is a side view, as viewed from the Y-axis direction, and FIG. 6B is a side view, as viewed from the X-axis direction.

As shown in FIGS. 6A and 6B, when the coil member 21 turns, the axis S of the lever 30 is pivoted on the second rotating axis Y from the neutral position to the left in the figure. The pivot position shown in FIGS. 5A and 5B in the X-axis direction is maintained. By reversing the direction of current to be passed through the coil portion 21C, the axis S of the lever 30 does not pivot on the first rotating axis X, but pivots rightward on the second rotating axis Y, as shown by “Sr” in FIG. 6A.

In this way, the axis S of the lever 30 can be pivoted in an arbitrary direction within the range permitted by the slit 26 by independently giving rotation commands from the external control circuit P to the driving circuit 42 for the first VCM 13 and the driving circuit 43 for the second VCM 23. The range permitted by the slit 26 is determined by the angle formed by both ends of the slit 26 and the pivot of the lever 30, and the maximum pivot angle of the lever 30 in the X-axis direction.

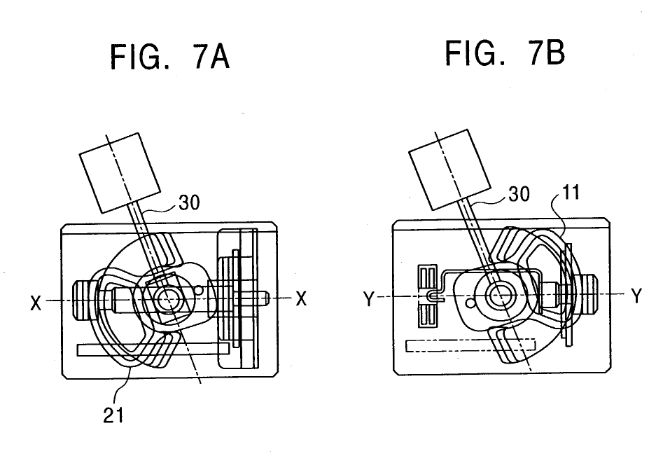

FIGS. 7A and 7B show a pivoting state of the lever 30 brought about when the first rotating member 10 and the second rotating member 20 are independently rotated according to rotation commands independently given to the driving circuit 42 for the first VCM 13 and the driving circuit 43 for the second VCM 23. FIG. 7A is a side view of the state, as viewed form the Y-axis direction, and FIG. 7B is a side view of the state, as viewed from the X-axis direction.

As shown in FIGS. 7A and 7B, when both the first and second rotating members 10 and 20 are rotated, the axis S of the lever 30 is tilted with respect to both the first and second rotating axes X and Y.

[Second Embodiment]

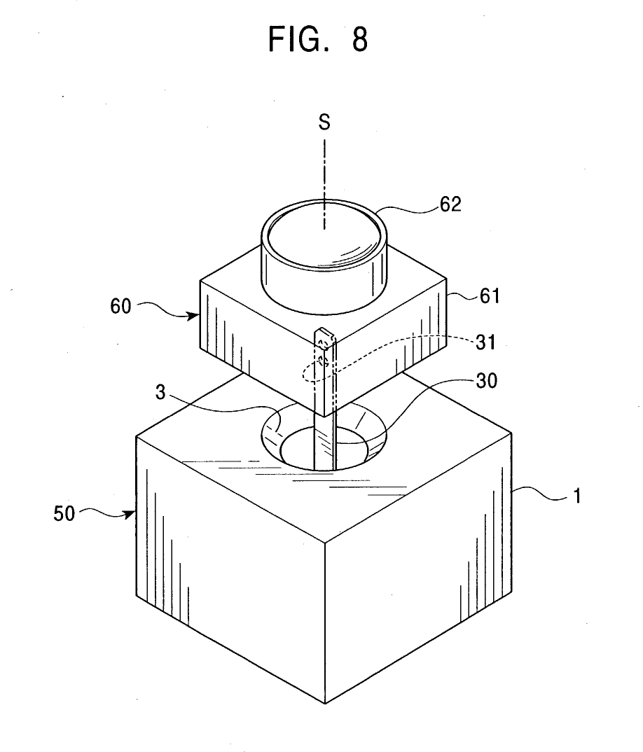

FIG. 8 is a perspective view of an optical apparatus according to a second embodiment of the present invention. An optical apparatus of the second embodiment includes the actuator 50 described in the first embodiment, and an optical device 60 such as a CCD camera. The optical device 60 is mounted at the leading end of the lever 30 through the connecting holes 31. The optical device 60 includes a camera body 61 and an image-taking lens 62 mounted at the leading end of the camera body 61. The optical axis of the image-taking lens 62 is aligned with the axis S of the lever 30. Although not shown, lines are led out from the optical device 60, and are connected to a power supply and an image-signal processing circuit mounted externally.

In the optical apparatus of the second embodiment, the optical device 60 is attached to the lever 30 of the actuator 50 described in the first embodiment while the optical axis of the image-taking lens 62 is aligned with the axis S of the lever 30. Therefore, when a rotation command is given to the driving circuit 42 for the first VCM 13 and the driving circuit 43 for the second VCM 23, the optical axis of the image-taking lens 62 can be freely moved in a wide range in the X-axis direction, the Y-axis direction, and any intermediate direction in response to the command, without inverting the image-taking screen vertically and horizontally. Moreover, scanning can be performed in a predetermined pattern. Since the optical device 60 is subjected a position-changing motion by the first and second VCMs 13 and 23, the size of the electrical moving mechanism is reduced, and precise and quick tilting control is possible. Even when the optical device 60 is forcibly moved by external force, the inner mechanism of the actuator 50 will not be broken. This is because the mechanism do not adopt gears, but adopts the first and second VCMs 13 and 23.

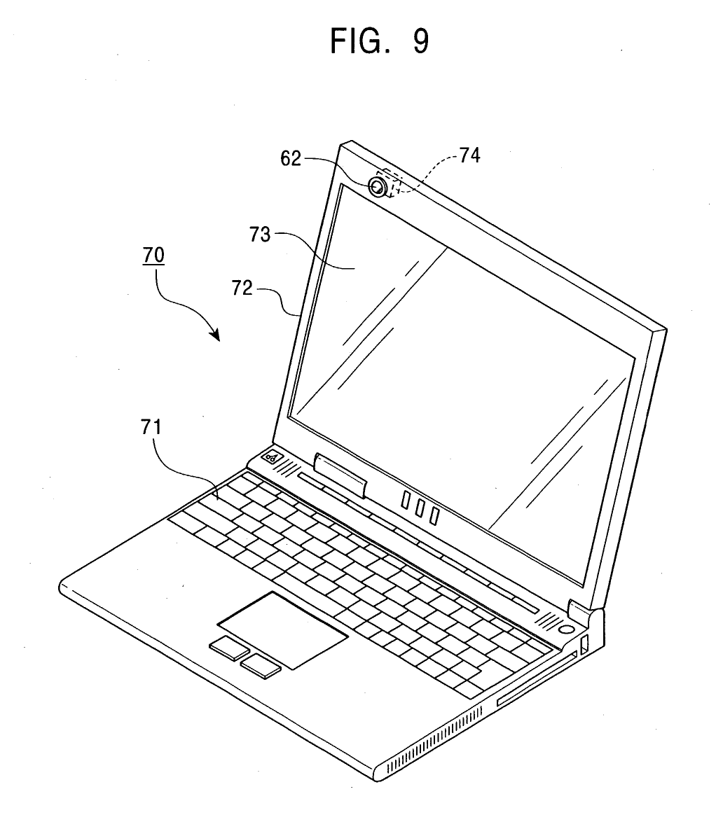

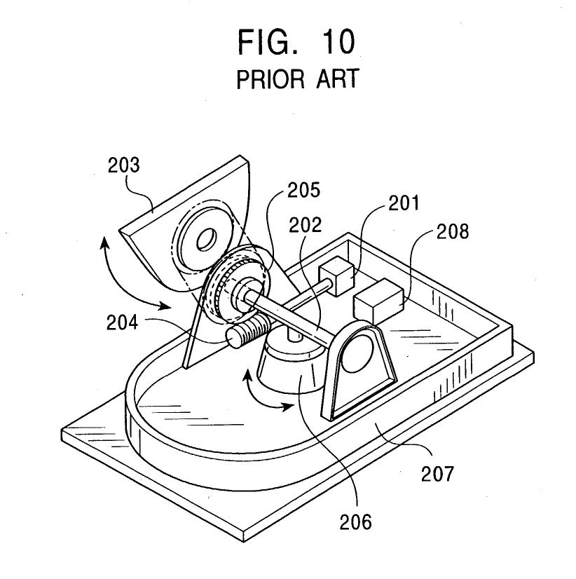

FIG. 9 is a perspective view of an example of a notebook personal computer (hereinafter referred to as a “PC”) in which the optical apparatus of the second embodiment is mounted.

In a PC 70, a keyboard section 71 and a display section 72 are pivotally connected by hinges. The display section 72 includes a liquid crystal display 73 and a window 74 disposed thereabove. The optical apparatus of the second embodiment shown in FIG. 8 is mounted inside the window 74 in a state in which the leading end of the image-taking lens 62 is exposed from the window 74. It is preferable that the window 74 have a size such as to cover the maximum moving range of the optical device 60.

Although not shown, a control circuit for controlling the circuits on the circuit board 40 and the optical device 60, such as a CCD camera, is provided together with a CPU inside the keyboard section 71.

Since the optical apparatus of this embodiment has a structure in which the optical device 60, such as a CCD camera, is mounted on the electronically-controlled small actuator (pan head), it can also be easily mounted in small information devices, such as portable telephones, other than the notebook personal computer shown in FIG. 9 without ignoring the request for size reduction. The viewing field of the optical device 60 can be panned or tilted in an arbitrary horizontal or vertical direction, or scanning can be performed, in response to a remote command from the keyboard section 71 or the like.

While the optical device 60, such as a CCD camera, is attached to the lever 30 in the second embodiment, of course, other optical devices can be tilted similarly. For example, a small-diameter fiberscope that can be electrically panned and tilted by remote control can be provided by mounting the actuator 50 of this embodiment at the leading end of the fiberscope and attaching an illuminating lamp and/or a camera to the lever 30. Furthermore, a compact laser radiation device capable of high-speed scanning can be provided by attaching a laser to the lever 30. An image-taking lens having a shake preventing function can be provided by attaching a lens serving as a part of an image-taking lens system to the lever 30. A multi-contact optical switch can be provided on the light guide path in the optical system by incorporating the actuator 50 of this embodiment in an optical device including an optical fiber, a mirror, a half mirror, and the like. Furthermore, the actuator of this embodiment may be incorporated in various small devices and toys other than the optical device in order to subject a predetermined member to a position-changing motion such as panning or tilting, for example, in order to wag a tail of a robot dog or to move the eyes of a robot doll.

What is claimed is:

1. An actuator comprising:
a first rotating member rotatable on a first rotating axis;
a second rotating member rotatable on a second rotating axis separately crossing the first rotating axis; and
a lever, having a portion for mounting an object, that converts the rotational motion of each of said first and second rotating members into a motion that changes the position thereof,
wherein at least one of said first and second rotating members is rotationally driven by a voice coil motor composed of a coil and a magnet that relatively move at a distance from each other.

2. An actuator according to claim 1, wherein said second rotating member has a slit extending along the second rotating axis, and the position of said lever is changed while said lever is born said first rotating member to pivot along the first rotating axis and to move in conjunction with the rotation of said first rotating member on the first rotating axis, and while said lever extends through said slit to pivot along the second rotating axis and to move in conjunction with the rotation of said second rotating member on the second rotating axis.

3. An actuator according to claim 1, further comprising:
a driving circuit for driving said voice coil motor.

4. An actuator according to claim 1, further comprising:
a measurement section for measuring the rotating position of each of said rotating members.

5. An optical apparatus comprising:
an optical device; and
an actuator comprising a first rotating member rotatable on a first rotating axis, a second rotating member rotatable on a second rotating axis separately crossing the first rotating axis, and a lever, having a portion for mounting said optical device, that converts the rotational motion of each of said first and second rotating members into a motion that changes the position thereof,
wherein said optical device is attached to said lever, and at least one of said first and second rotating members is rotationally driven by a voice coil motor composed of a coil and a magnet that relatively move at a distance from each other.

6. An optical apparatus according to claim 5, wherein said optical device is attached to said lever so that an optical axis or an extension line thereof is aligned with or is in parallel with the axis of said lever.
